(19) United States
(12) Patent Application Publication
(10) Pub. No.: US 2015/0349410 A1
(43) Pub. Date: Dec. 3, 2015

(54) ANTENNA SYSTEM AND METHOD OF ASSEMBLY FOR A WEARABLE ELECTRONIC DEVICE

(71) Applicant: MOTOROLA MOBILITY LLC, Chicago, IL (US)

(72) Inventors: Michael E. Russell, Lake Zurich, IL (US); Katherine H. Coles, Geneva, IL (US); Abu T. Sayem, Gurnee, IL (US)

(21) Appl. No.: 14/339,476

(22) Filed: Jul. 24, 2014

Related U.S. Application Data
(60) Provisional application No. 62/006,316, filed on Jun. 2, 2014.
(60) Provisional application No. 62/016,884, filed on Jun. 25, 2014.

(51) Int. Cl. H01Q 1/27; G04R 60/06; H01Q 13/10

(52) U.S. Cl. CPC H01Q 1/273; H01Q 13/10; G04R 60/06

(57) ABSTRACT

An antenna system for a wearable electronic device includes a first conductive surface constructed from a segment of outer housing of the wearable electronic device. The first conductive surface spans a first axis through the wearable electronic device. The antenna system also includes a second conductive surface that spans the first axis. The second conductive surface is constructed from a set of contacting metal components that are internal to the wearable electronic device. The first and second conductive surfaces are separated by a space. The antenna system also has a contact element having a feeding element that connects the first conductive surface to the second conductive surface along a plane that is normal to the first conductive surface.

### RELATED APPLICATIONS

The present application is related to and claims benefit under 35 U.S.C. §119(e) from U.S. Provisional Patent Application Ser. Nos. 62/006,316 filed Jun. 2, 2014 and 62/016,884 filed Jun. 25, 2014, the entire contents of each being incorporated herein by reference.

### FIELD OF THE DISCLOSURE

The present disclosure relates to an antenna system for a wearable electronic device and more particularly to an antenna system constructed from an outer housing of the wearable electronic device.

### BACKGROUND

As electronics evolve, items that are commonly worn on a person's body are adapted to perform additional functions. For example, some wristwatches and eyeglasses are fitted with electronics to perform functions such as visual recordings and wireless transmission. One shortcoming, however, in such devices is a tradeoff between stylish appearance and electronic performance. More particularly, for some electronics, high performance is achieved at the expense of concessions in appearance, and an elegant appearance is achieved by compromising performance.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a diagram illustrating a wearable electronic device configured with an antenna system in accordance with an embodiment.

FIG. 2 illustrates an exploded view of various components of a wearable electronic device configured with an antenna system in accordance with an embodiment.

FIG. 3 illustrates a cross-sectional view and a plan view of components of a wearable electronic device configured with an antenna system in accordance with an embodiment.

FIG. 4 illustrates another plan view of components of a wearable electronic device configured with an antenna system in accordance with an embodiment.

FIG. 5 illustrates another cross-sectional view of components of a wearable electronic device configured with an antenna system in accordance with an embodiment.

FIG. 6 illustrates two views of a contact element for an antenna system in accordance with an embodiment.

FIG. 7 illustrates a cross-sectional view and an overhead view of components of a wearable electronic device configured with an antenna system in accordance with an embodiment.

FIG. 8 illustrates another cross-sectional view and overhead view of components of a wearable electronic device configured with an antenna system in accordance with an embodiment.

FIG. 9 shows a flow diagram illustrating a method for assembling a wearable electronic device having a slot antenna in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to the various embodiments, the present disclosure provides for an antenna system for a wearable electronic device. In one example embodiment, the antenna system includes a first conductive surface constructed from a segment of outer housing of the wearable electronic device. The first conductive surface spans a first axis through the wearable electronic device. The antenna system also includes a second conductive surface that spans the first axis. The second conductive surface is constructed from a set of contacting metal components that are internal to the wearable electronic device. The first and second conductive surfaces are separated by a space. In one example embodiment, the antenna system also includes a contact element having a feeding element that connects the first conductive surface to the second conductive surface along a plane that is normal to the first conductive surface.

In another implementation, a wearable electronic device includes a rear housing component and a front housing component. The front housing component is connected to the rear housing component at a first edge, and the front housing component has an opening at a second opposing edge. The wearable electronic device also includes internal components at least partially enclosed by the front and rear housing components. The internal components include a display having a surface that spans the opening of the front housing component. The wearable electronic device further includes an antenna system in accordance with an embodiment. The antenna system has a first conductive surface constructed from a segment of the front housing component. The first conductive surface is disposed normal to the surface of the display. The antenna system also includes a second conductive surface disposed normal to the surface of the display. The second conductive surface is constructed from a set of contacting metal components of the internal components. The first and second conductive surfaces are separated by a space. The antenna system further includes a contact element having a feeding element that connects the first conductive surface to the second conductive surface along a direction that is normal to the first conductive surface.

In accordance with yet another embodiment is a method for assembling a wearable electronic device having a slot antenna. The method includes layering a contact element, a printed circuit board, and a display onto at least one of a rear housing component or a front housing component. The layering is performed along a first axis. The method further includes connecting the front housing component to the rear housing component to assemble the wearable electronic device such that a lateral surface of the front housing component extends along the first axis, wherein the connecting creates a slot antenna. The created slot antenna includes first and second conductive surfaces disposed along the first axis and separated by a space and further includes the contact element. The first conductive surface is constructed from a segment of the lateral surface of the front housing component. The second conductive surface is constructed from a segment of the printed circuit board and a segment of at least one metal element disposed between the printed circuit board and the display. A feeding element of the contact element connects the first conductive surface to the segment of the printed circuit board along a direction that is normal to the first conductive surface.

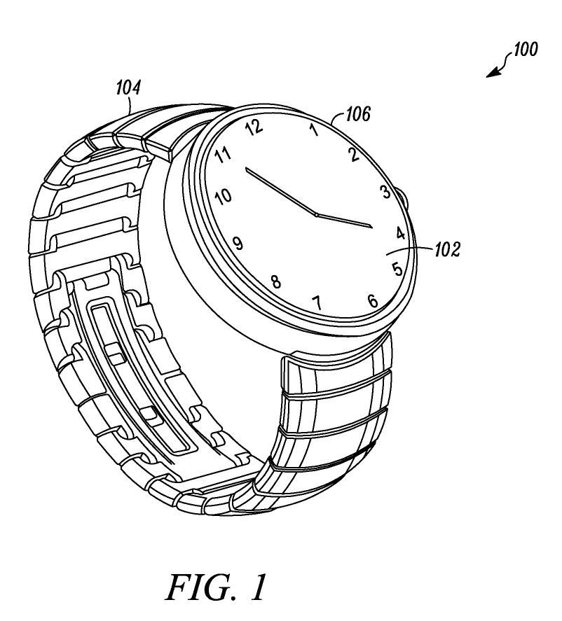

Turning to the drawings, FIG. 1 illustrates a representative wearable electronic device 100 in which embodiments of an antenna system can be implemented. The wearable electronic device 100 includes a portable electronic device 106, in this case a smartwatch, having a display assembly 102. The wearable electronic device 100 further includes a wearable element 104 attached to the portable electronic device 106, in this case a wristband 104, which allows the portable electronic device 106 to be worn on a person's body. The present disclosure refers to a smartwatch or wrist-worn electronic device to illustrate embodiments of the antenna system. However, the antenna system and method for assembling a wearable electronic device that includes the antenna system, described herein, can be applied to any electronic device that can operate using an antenna. Such devices include, but are not limited to: other types of wearable electronic devices such as eyewear that incorporates a portable electronic device; portable electronic devices for monitoring body functions such as heart rate monitors and pulse monitors; and the like.

In the example smartwatch 100 of FIG. 1, the display assembly 102 is circular and can display information such as the current date and time, notifications, images, and the like. In the embodiment shown, the display assembly 102 is implemented as an analog watch-face that displays the current time using multiple rotating hour and minute pointers or hands that point to numbers arranged around a circumference of the display assembly 102. In other embodiments, the watch-face digitally displays information such as the current date and time as a sequence of alpha-numeric digits. In further embodiments, the display assembly 102 hosts a user interface through which the smartwatch 100 can be configured and controlled. In yet other embodiments, the display assembly 102 has another shape, such as square, rectangular, oval, etc.

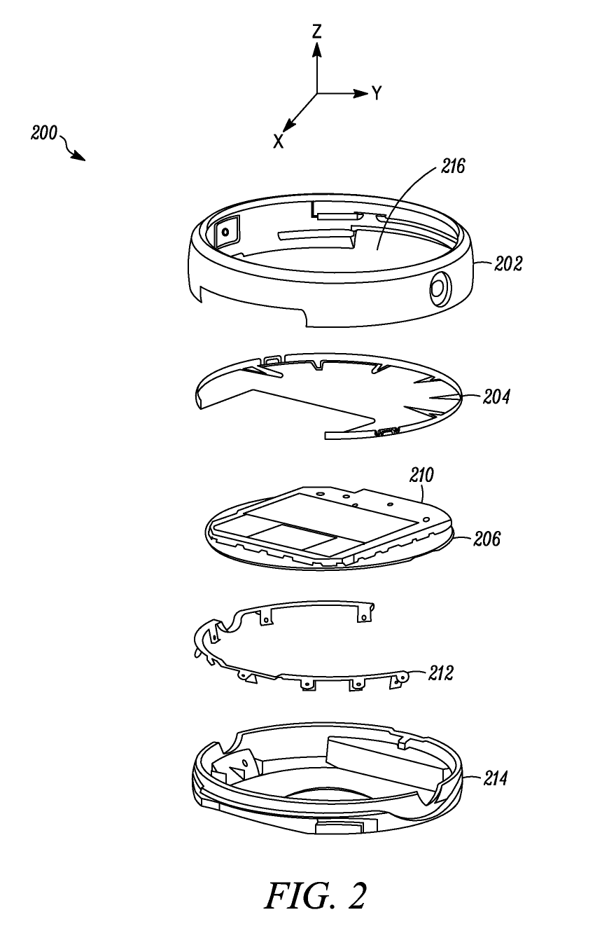

FIGS. 2-8 illustrate different views of an electronic device, such as the smartwatch 100, that incorporates the present teachings. Therefore, when describing FIGS. 2-8, reference will be made specifically to the smartwatch 100 shown in FIG. 1, although the principles described can be applied to other types of electronic devices. In FIG. 2 some components 200 the smartwatch 100 are shown in an exploded view. Illustratively, the smartwatch 100 incorporates the components 200 in a “stack,” wherein a plurality of internal components including a display bezel 204, a printed circuit board (PCB) 206, a shield 210, and a contact element 212 are stacked or layered on top of one another and enclosed within a cavity of front 202 and rear 214 outer housing components. Front and rear housing components are also referred to herein as front and rear housing. As shown, the components 202, 204, 206, 210, 212, and 214 are stacked along a Z axis, which is also referred to herein and in the claims as a first axis. FIG. 2 shows one illustrative layering or stacking of the components 200 of the smartwatch 100. In other embodiments, however: some of the components 200 are disposed in different locations of the stack; major components are combined into a unitary component; and other components, not shown in FIG. 2, are included to accomplish specific tasks.

Further to the details of the illustrative component stack 200, the front housing component 202 has a cylindrical shape with a cavity in the center that is sufficiently deep to enclose or contain most or all of the internal components of the device 100. The front housing component 202 is constructed from a conductive material, such as any suitable metal, to enable a segment of the front housing component 202 to form part of an antenna system or antenna for short, in accordance with the present disclosure, for the smartwatch 100. Namely, a first conductive surface of the antenna is constructed from a portion of the front housing component 202.

The display bezel 204 is disposed between a display assembly (not shown in FIG. 2) and the PCB 206, and provides support for the display assembly after the device 100 is assembled. Also, when assembled, a lens or touchscreen of the display assembly extends through an opening 216 of the front housing component 202. An example display assembly includes a number of layers that are adhesively attached to the front housing 202. For example, layers of a liquid crystal display (LCD) assembly include, but are not limited to, polarizing films, glass substrates, and an LCD panel. Resistive touchscreens include, for instance, multiple electrically resistive layers. Capacitive touchscreens include multiple layers assembled to detect a capacitive impingement on the touchscreen.

Electronic components on the PCB 206 provide most of the intelligent functionality of the device 100. The PCB 206 illustratively includes electronic components, such as, one or more communication elements, e.g., transceivers, that enable wireless transmission and reception of data. One example PCB 206 also includes media-capture components, such as an integrated microphone to capture audio and a camera to capture still images or video media content. Various sensors, such as a PhotoPlethysmoGraphic sensor for measuring blood pressure, are disposed on some PCBs 206. Still other PCBs 206 have processors, for example one or a combination of microprocessors, controllers, and the like, which process computer-executable instructions to control operation of the smartwatch 100. In still other examples, the PCB 206 includes memory components and audio and video processing systems. In this example component stack, the shield 210 is positioned over the PCB 206 to protect the electronic components arranged on the PCB 206.

The contact element 212 is another component of the antenna system, for the electronic device 100, in accordance with the present teachings. For some embodiments, the antenna system is arranged as a slot antenna, wherein the contact element 212 connects the first conductive surface of the antenna (that functions as a radiator) with a second conductive surface of the antenna (that functions as electrical ground), to drive the antenna. Further, the contact element 212 tunes the antenna based on how the contact element 212 is configured. An example contact element 212 is constructed from a conductive material, e.g., any suitable metal.

In an embodiment, the contact element 212 is configured to electrically connect the front housing 202, from which the first conductive surface of the antenna is constructed, to the printed circuit board 206, which is one contacting metal component of a second conductive surface of the antenna system for the device 100. In a particular embodiment, the display bezel 204 and the shield 210 are also contacting metal components that make up the second conductive surface. “Contacting” metal components or elements are internal components of a device that are physically connected or physically touch at some metal segment of the components to provide a continuous electrical connection along multiple conductive surfaces, for instance to provide an electrical ground for a slot antenna. A contacting metal component need not be constructed entirely of metal. Only the segment of the contacting metal component that makes up part of the second conductive surface needs to be constructed of metal.

The rear housing component 214 is made of any suitable non-conductive or non-metallic material, with ceramic used in some embodiments and plastic used in other embodiments. Using a non-metallic material for the rear housing 214 prevents inadvertent electrical connections between the first and second conductive surfaces of the antenna, which would negatively impact the antenna's functionality. In one particular embodiment, the wristband 104 (see FIG. 1) or other wearable element attaches to the rear housing 214 with wristband-attachment pins (not shown) or via another well known mechanism. Housing-attachment pins (not shown) are one possible mechanism for connecting the rear housing 214 to the front housing 202. In a further embodiment, a separate endplate (not shown) covers the rear housing 214.

As mentioned above, in one example, the device 100 includes an antenna system that can be configured to operate as or in accordance with principles of operation of a slot antenna. Namely, conventional slot antennas are constructed by creating a narrow slot or opening in a single metal surface and driving the metal surface by a driving frequency such that the slot radiates electromagnetic waves. For some implementations, the slot length is in the range of a half wavelength at the driving frequency.

By contrast, instead of an opening being cut into a single metal surface to create the slot antenna, the present teachings describe a space, gap or aperture (the effective “slot”) located between first and second conductive surfaces of an antenna system, wherein the antenna system can be configured to radiate electromagnetic waves at a desired frequency through this slot, also referred to herein as a radiating slot. In essence, an antenna system in accordance with the present teachings can be termed as a “slot” antenna since it can be configured to radiate, through the space or slot between the first and second conductive surfaces, electromagnetic waves having a substantially similar pattern to the electromagnetic waves radiated through the opening of a conventional slot antenna. More particularly, in accordance with an embodiment, the antenna system can be configured with an aperture between the first and second conductive surfaces that has a length that is in the range of a half wavelength at the driving frequency.

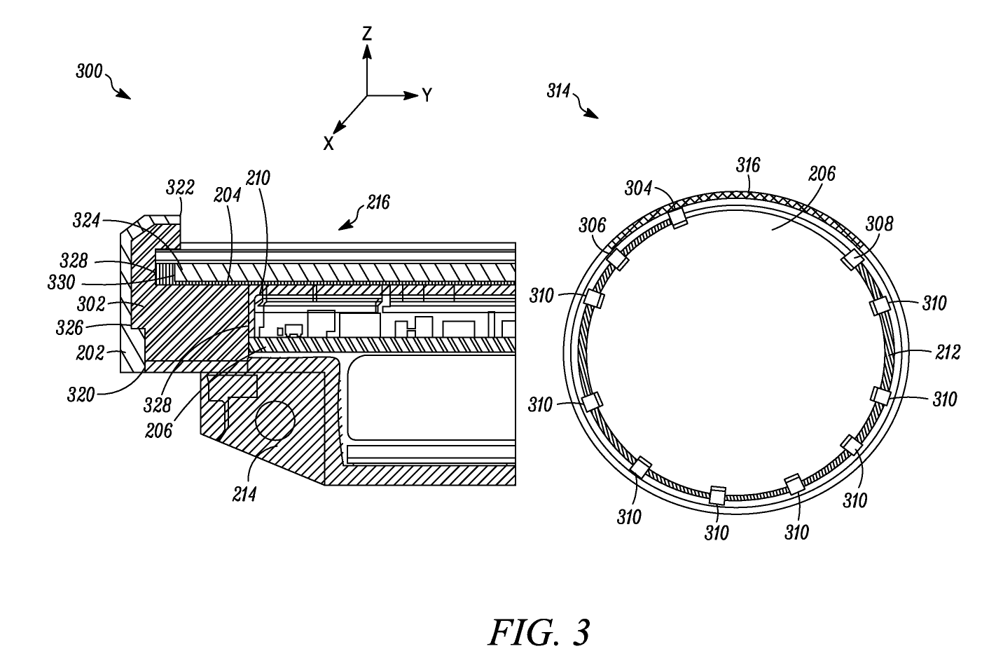

FIG. 3 shows a cross-sectional view 300 of the components 202, 204, 210, 206, and 214 when the smartwatch 100 is assembled. More specifically, when assembled, the front housing component 202 is connected to the rear housing component 214 at a first edge 320 of the front housing component 202. The front 202 and rear 214 housing components may also be connected at areas other than the edge 320. The opening 216 of the front housing component 202 is at a second opposing edge 322 of the front housing component 202. The front and rear housing components 202, 214 at least partially enclose the internal components, e.g., 204, 206, 210, and 212, of the device 100.

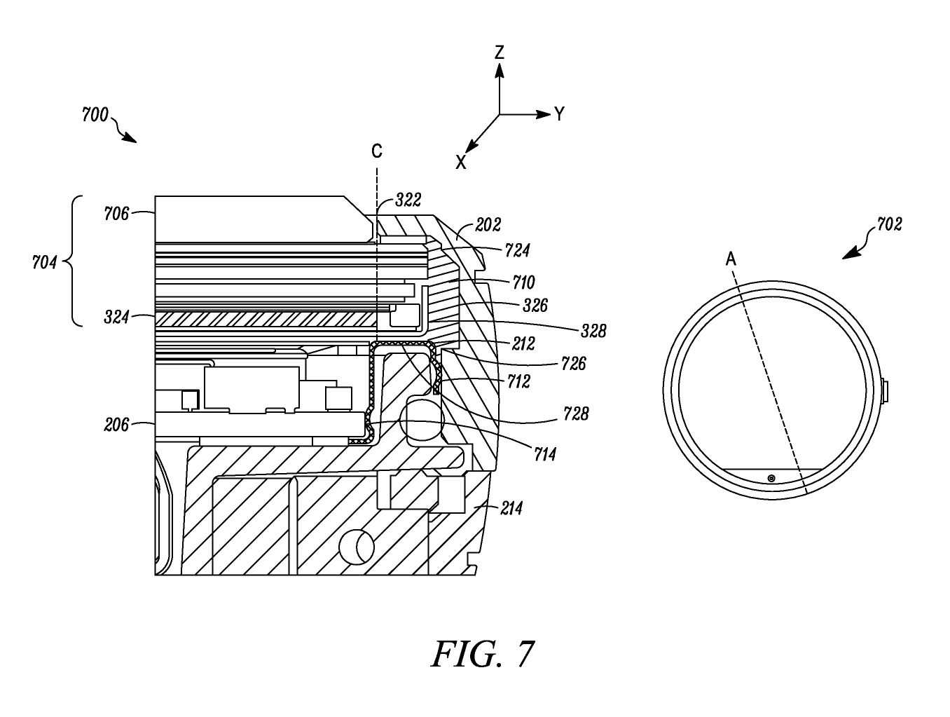

The internal components also include a display 324 that spans the opening 216 of the front housing component 202. As used herein, a “display” of a display assembly is the element or panel, for instance an LCD panel or capacitive element panel, upon which pixels of an image or picture, video, or other data are shown. Properties of the display 324 are described in greater detail in relation to FIG. 7. A surface spans an axis or opening when the surface extends over or across the axis or opening in the same direction of the axis or opening. A first surface spans a second surface when the first surface extends at least partially over or across the second surface in the same direction as the second surface, wherein there is at least some overlap between the two surfaces. It should be noted that for one surface to span another surface, the two surfaces need not be directly adjacent to one another. Similarly, for a surface to span an opening, the surface need not be directly adjacent to the opening.

Illustratively, an edge 330 of the surface of the display 324 aligns with the second edge 322 of the front housing component 202. Thus, the display 324 spans the opening 216 such that there is no mask positioned between edges of the display 324 and the second opposing edge 322 of the front housing component 202. Accordingly, when a user views the electronic device 100 from above, the display 324 can be configured to display images in a region that spans the full area of the opening 216, which beneficially provides for a device that has an edge-to-edge display.

The cross-sectional view 300 further illustrates an antenna system, in accordance with the present teachings, having first 326 and second 328 conductive surfaces that are separated by a space 302 that can radiate electromagnetic waves as a slot antenna. In this example, the first conductive surface 326 is constructed from a segment of outer housing of the wrist-worn electronic device 100. In a particular embodiment, the first conductive surface 326 for the antenna system is formed using an inner surface of the front housing component 202. In this case, the front housing component 202 has a cylindrical shape such that the segment of the outer housing from which the first conductive surface 326 is constructed is curved. Where the outer housing has a different shape, such as cuboid, the segment of the outer housing from which the first conductive surface 326 is constructed can have right angles.

Illustratively, the first conductive surface 326 is also seamless, meaning that the first conductive surface is a continuous piece of metal in an area where currents flow when the antenna system is operating, notwithstanding the continuous piece having openings for buttons and such. This seamlessness enables the current generated during the operation of the antenna system to be maintained within the inner surface of the front housing component 202, as opposed to escaping through a discontinuity in the housing component. This allows more efficient operation of the antenna system. As further illustrated in the cross-sectional view 300, the first conductive surface 326 spans a first axis, which in this case is the Z axis, through the electronic device 100. In relation to the display 324, which has a surface that spans the X and Y axes, the first conductive surface 326 is disposed normal to the surface of the display 324.

Also illustrated in cross-sectional view 300, the second conductive surface 328 is constructed from a set of contacting metal components that are internal to the electronic device. As used herein, a set includes one or more of a particular item. As mentioned above, in this case, the second conductive surface 328 is constructed from the set of contacting metal components which includes the internal components of the PCB 206, the shield 210, and the display bezel 204. In this embodiment, the second conductive surface 328 is constructed from adjacent contacting metal surfaces of each of the internal components 204, 206, and 210.

Particularly, the PCB 206 is disposed adjacent to, in this case directly adjacent to, the rear housing component 214. The shield 210 is disposed directly adjacent to the PCB 206. The display bezel 204 is disposed directly adjacent to the shield 210 and the display 324. Two items that are adjacent to each other are near or in the vicinity or proximity of each other. Directly adjacent items contact one another in at least one location. Accordingly, the second conductive surface 328 that is formed from the contacting metal segments of the adjacent internal components 204, 206, and 210 is also disposed along the Z axis normal to the surface of the display 324.

A properly performing antenna radiates, meaning communicates by sending and/receiving, radio waves (also referred to herein as signals) in a desired frequency range, referred to herein as the desired radiating frequency or the radiating frequency of the antenna, using a radiating structure that is driven by at least one feeding element. The antenna further suppresses one or more undesired or unwanted radiating frequencies, referred to herein as frequencies outside the desired radiating frequency, using at least one suppression element. In some embodiments, the contact element 212 is configured to perform the functions of setting and feeding the desired radiating frequency and suppressing unwanted frequencies.

FIG. 3 illustrates an overhead view 314 of the device 100 showing an example contact element 212 in accordance with the present teachings. The view 314 omits many of the components of the device 100 shown in the cross-sectional view 300 to focus on the contact element 212 in the context of the device 100 as a whole. As shown, the contact element 212 includes a plurality of legs 304, 306, 308, and 310, which are also referred to herein as extensions. In some embodiments, the extensions 304, 306, 308, and 310 connect the first electrical conductor 326 to the second electrical conductor 328 at different location along the PCB 206 and the front housing component 202. Moreover, the extensions 304, 306, 308, and 310 have a substantially similar construction, but perform different functions. Namely, the extension 304 operates as a feeding element; the extensions 306 and 308 operate as frequency setting elements, and the extensions 310 operate as frequency suppression elements, as explained in further detail below. Further, the extensions 304, 306, 308, and 310 define physical characteristics of an antenna system for the device 100, in accordance with the present teachings.

For one embodiment, the extensions 304, 306, 308, and 310 define physical characteristics of a slot antenna having a radiating slot 316 formed between the first 326 and second 328 conductive surfaces. During operation, the antenna system radiates electromagnetic waves through the radiating slot 316 at the desired radiating frequency. The length of the radiating slot 316 affects the radiating frequency at which the antenna operates and is defined by the position of the legs 306 and 308. Particularly, the leg 306 is located coincident with a first end of the radiating slot 316, and the leg 308 is located coincident with a second end of the radiating slot 316. Accordingly, the legs 306 and 308 operate as first and second frequency setting elements the locations of which control the radiating frequency for the slot antenna having the slot 316.

In other examples, the frequency setting elements 306 and 308 are located closer or further apart, which changes the length of the slot 316, thereby, changing the radiating frequency of the slot antenna. The feeding element 304 is illustratively located between the first and second legs 306 and 308 and functions to drive the first conductive surface 326, which operates as a radiating structure, to generate and radiate radio waves at the desired radiating frequency through the slot 316.

Similar to some other antenna structures, an antenna in accordance with the present teachings operates in a particular frequency range. If the antenna emanates signals outside of this frequency range, the effectiveness of the antenna is compromised. Thus, such undesired frequencies should be suppressed. Accordingly, in an embodiment, the contact element 212 includes the set of frequency suppression elements 310, which operate to suppress one or more undesired radiating frequencies. Particularly, the frequency suppression elements 310 minimize the space between the first 326 and second 328 conductive surfaces in circumferential areas of the device 100 other than the slot 316 to, thereby, minimize the radiation of frequencies that are not within the range of operating frequencies for the antenna. Although in this embodiment eight frequency suppression elements 310 are shown, in other embodiments the device 100 includes more or fewer frequency suppression elements 310. Further, locations of the frequency suppression elements 310 may vary relative to one another in different embodiments depending on which frequencies are to be suppressed.

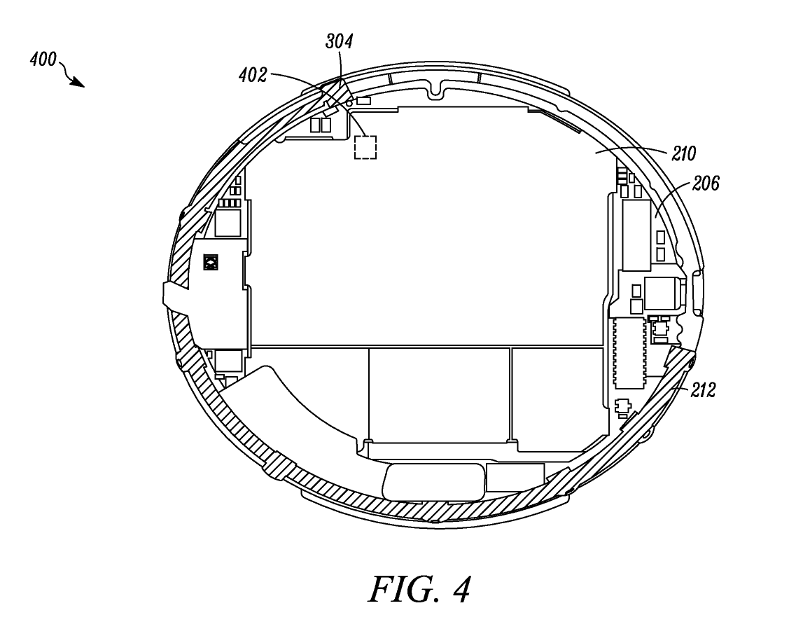

FIG. 4 illustrates a plan view 400 of the device 100 looking down through the opening 216 of the outer housing 202. The view 400 shows the contact element 212, the PCB 206 with various electronic components arranged thereon, and the shield 210. In one example, the components arranged on the PCB 206 include a wireless transceiver 402 disposed near the feeding element 304. The wireless transceiver 402 communicates device data using the feeding element 304. Namely, the feeding element 304 is electrically connected to the wireless transceiver 402, for instance using metal traces that are not shown. The feeding element 304 also connects to the first conductive surface 326, which is constructed from the outer housing 302. The first conductive surface 326 operates as a radiating element to communicate wireless signals carrying device data between the wireless transceiver 402 and wireless transceivers of external devices.

The wireless transceiver 402 is configured with hardware capable of wireless reception and transmission using at least one standard or proprietary wireless protocol. Such wireless communication protocols include, but are not limited to: various wireless personal-area-network standards, such as Institute of Electrical and Electronics Engineers (“IEEE”) 802.15 standards, Infrared Data Association standards, or wireless Universal Serial Bus standards, to name just a few; wireless local-area-network standards including any of the various IEEE 802.11 standards; wireless-wide-area-network standards for cellular telephony; wireless-metropolitan-area-network standards including various IEEE 802.15 standards; Bluetooth or other short-range wireless technologies; etc.

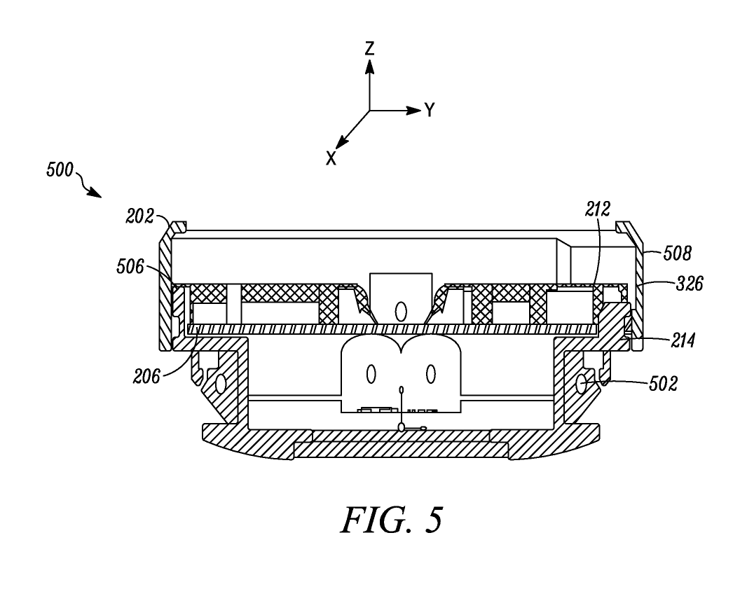

Turning now to FIG. 5, which illustrates a cross-sectional view 500 of the device. During assembly of the device 100, the front housing 202 is engaged with the rear housing component 214 by applying forces along the Z axis which is substantially normal to a top surface of the PCB 206, which spans the X and Y axes. The cross-sectional view 500 also illustrates that, in one example, the contact element 212 is disposed on an upper surface 506 of the rear housing component 214.

View 500 further shows that the first conductive surface 326 extends down to the rear housing component 214. Consequently, some embodiments of the electronic device can include a metal component, such as wristband 104, connected to an outside surface 508 of the front housing component proximal to the first conductive surface 326. The metal component can further be proximal to a region, within the space between the first and second conductive surfaces, which contains current when the antenna system is operating without affecting the antenna's transmission properties as long as the metal component is not positioned such as to electrically short together the first and second conductive surfaces.

In one embodiment, the device 100 includes a receptacle 502 configured to receive an attachment pin (not pictured). The attachment pin is shaped to fit a loop in the wristband 104 to hold the device 100 to a user's wrist. Depending on the embodiment, the attachment pin is made of metal, plastic, ceramic or another material suitable to hold the wristband 104 to the device 100. Also depending on the embodiment, the band 104 is made of metal, leather, or any other material capable of securely holding the device 100 to a user's wrist. Because currents of a slot antenna in accordance with the present teachings flow inside the slot area, objects made of metal or any other materials placed in contact with an external surface of the front housing 202 do not affect antenna performance. Thus, if the device 100 is fitted with a metal attachment pin and/or wristband, the antenna 316 maintains its transmission properties and thus there is no need to retune the antenna.

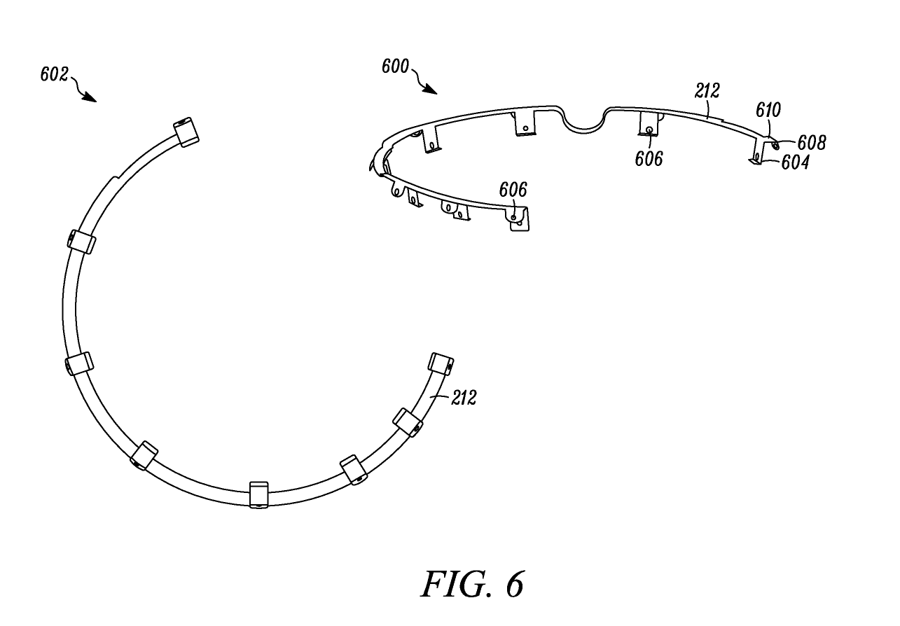

FIG. 6 shows two views 600 and 602 of the contact element 212 and its extensions 610. As previously described, the extensions are configured to perform various functions including frequency setting and frequency suppression. The views 600, 602 illustrate that the contact element 212 is formed into a single piece of metal. Thus, as FIG. 3 in conjunction with FIG. 6 show, the first and second frequency setting elements 306 and 308 and at least one frequency suppression element 310 are constructed into a single piece of metal, such as the contact element 212. Further, the single piece of metal is curved. Because the contact element 212 is disposed on an upper edge 506 of the rear housing 214 that is substantially concentric with the front housing component 202, the single piece of metal has a curvature that corresponds to a curvature of the outer housing 202 of the wearable electronic device 100. Further, the front housing component 202 has a cylindrical shape (see FIG. 2), and the contact element 212 has a semi-circular shape that conforms to the cylindrical shape of the front housing 202 and that sits within the rear housing component 214.

The extensions 610 span downward from a top portion of the contact element 212 to form a “U” shaped piece, which is capable of receiving the upper edge 506 of the rear housing 214. When the contact element 212 is disposed on the rear housing 214, a first side 608 of the contact element 212 is positioned to contact the first conductive surface 326 and a second side 604 is positioned to contact the second conductive surface 328.

Each of the first 608 and second 604 sides of the extensions 610 have a spherical protrusion 606 which serves as a contact point between the contact element 212 and other surfaces, such as the first 326 and second 328 conductive surfaces. When the device 100 is assembled, the front housing component 202 is positioned over the rear housing component 214 such that the extensions 610 of the contact element 212 flex to connect the first conductive surface 326 to the second conductive surface 328, at least at the spherical protrusions 606.

FIG. 7 illustrates views 700 and 702 showing aspects of the contact between the contact element 212 and the first 326 and second 328 conductive surfaces of the device 100. Views 700 and 702 also show the display 324 within a display assembly 704, and the first 326 and second 328 conductive surfaces in greater detail. A location of a cross-section ‘A’ through the device 100 is illustrated in the overhead view 702. The view 700 shows a cut-away view of the device 100 at the cross-section ‘A’.

The display assembly 704 includes a lens 706, the display 324, and other components, for instance various other layers as described above for an LCD display. The display 324 is configured to generate an image that is projected through the lens 706 to a user of the device 100. The display 324 is arranged within the device 100 such that the edge 330 of the surface of the display 324 aligns with the second edge 322 of the front housing component 202. The alignment of the edge 330 of the display 324 with the second edge 322 is illustrated at ‘C’.

View 700 also shows a leg 728 of the contact element 212, which represents a feeding element, a frequency suppression element, or a frequency setting element. When the contact element 212 is disposed on the lower housing 214 and the lower housing 214 is assembled with the front housing 202, the legs of the contact element 212 are compressed along one or both of the X and Y axes. This compression allows a feeding element, for instance, of the contact element 212 to connect the first conductive surface 326 to the second conductive surface 328 along a plane (in this case the X-Y plane) that is normal to the first conductive surface 326 (in this case the Z axis).

In one example, the leg 728 is compressed to connect the first conductive surface 326 at a contact point 712 and the second conductive surface 328 at another contact point 714. The leg 728 exerts a force in the X-Y plane to maintain the contact points 712 and 714 with the first 326 and second 328 conductive surfaces, respectively. In one particular example, the extension 728 is a feeding element which connects at the contact point 714 a segment of the PCB 206, which is one of the contacting metal components of the second conductive surface 328, to the first conductive surface 326 at the contact point 712.

When the device is assembled, a space 710, which illustratively forms portion of the slot antenna, is formed between the first conductive surface 326 and the second conductive surface 328. This space 710 varies in size and dimension depending on in which cross-section of the device 100 the space 710 is created. The variations in the size of the space between the first and second conductive surfaces sometimes differ because of the arrangement of the set of contacting metal components composing the second conductive surface 328 in spatial relationship to the first conductive surface 326. In other cases, a portion of the front housing component 202 has a different thickness at different locations, which affects the dimensions of the space 710.

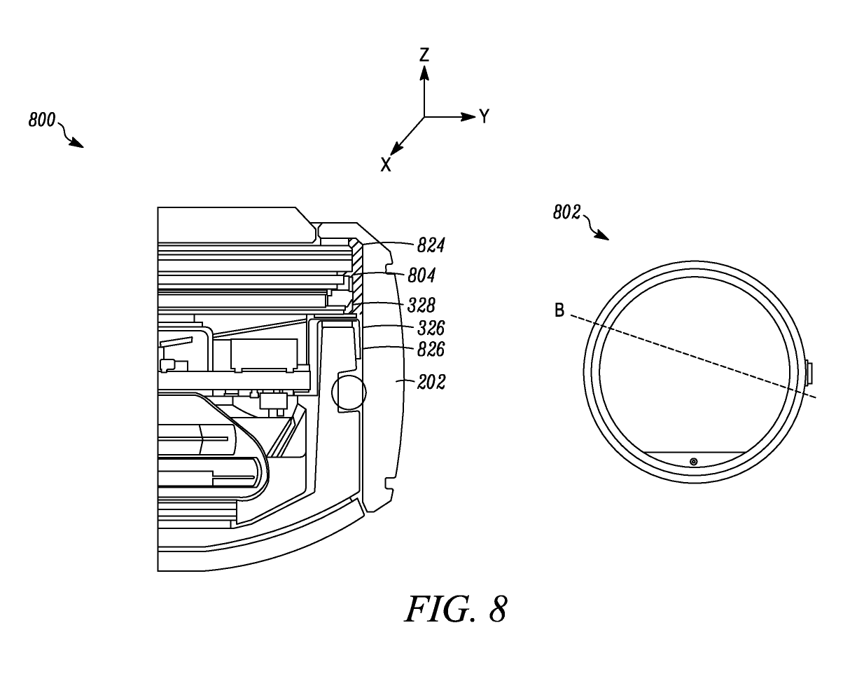

FIG. 8 shows views 800 and 802 to allow the comparison of aspects of FIG. 8 with FIG. 7. A location of a cross-section ‘B’ through the device 100 is illustrated in the overhead view 802. The view 800 shows a cut-away view of the device 100 at the cross-section ‘B’. Similar, to the cross-section illustrated in FIG. 7, the device 100 is configured to have a space 804 between the first conductive surface 326 and the second conductive surface 328. The space 804 illustrated in FIG. 8, however, is smaller than the space 710 between the first 326 and the second 328 conductive surfaces illustrated in FIG. 7. The difference in the size of the space between the two conductive surfaces is attributable to a cut or core-out partially shown in FIG. 7. At cross-section ‘A’, a portion of the front housing 202 stretching from 724 to 726 is “cored-out” to facilitate communicating electromagnetic waves using the antenna system of the present teachings. This same region 824, 826 remains intact at cross-section ‘B’ illustrated in view 800 to facilitate suppressing unwanted frequencies. Consequently the space 710 between first conductive surface 326 and the second conductive surface 328 in view 700 is larger than the space 804 illustrated in view 800. This change in the size of the spaces 710, 804 shows that at least one dimension of the space 710, 804 between the first 326 and second 328 conductive surfaces changes.

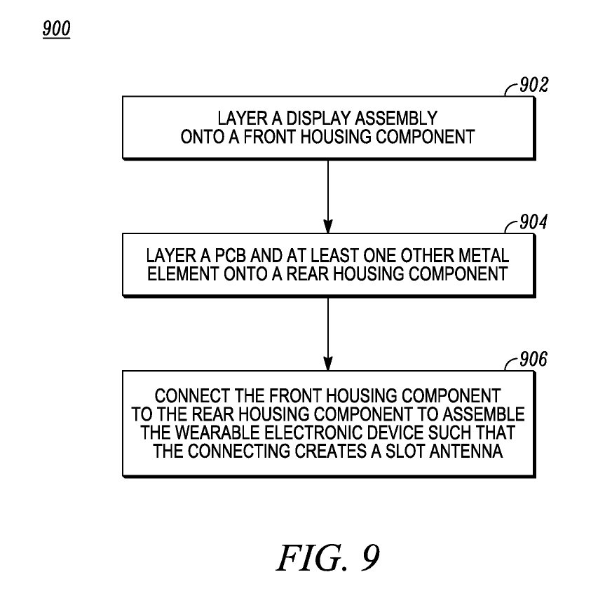

FIG. 9 illustrates is a method 900 for assembling a wearable electronic device having a slot antenna. In one example, the method includes layering the contact element 212, the printed circuit board 206, and the display 324 onto at least one of the rear housing component 214 or the front housing component 202. In the particular embodiment illustrated by reference to method 900, a display assembly, e.g., 704 of FIG. 7, is layered 902 onto and bonded to the front housing component 202. Moreover, the PCB 206 and at least one other metal component, for instance as shown in FIG. 2, is layered 904 onto the rear housing component 214.

The method 900 also includes connecting 906 the front housing component 202 to the rear housing component 214 to assemble the wearable electronic device 100 such that a lateral surface of the front housing component 202 extends along the Z axis. The layering is performed in the Z axis which is normal to a face of the display 324. This layering entails applying forces along the Z axis to bring these components together. Connecting the front housing component 202 to the rear housing component 214 creates a slot antenna having an aperture 316 in accordance with the present teachings, for instance as described above by reference to FIGS. 1 to 8.

In the particular embodiment described by reference to FIGS. 1 to 8, layering the contact element comprises disposing adjacent to a cylindrical rear housing component 214 a semi-circular metallic ring 212 having formed therein the feeding element 304. Connecting the front housing component 202 to the rear housing component 214 comprises connecting a cylindrical front housing component 202 to the cylindrical rear housing component 214 to assemble a wrist-worn electronic device 100.

The disclosed device 100 illustrated a cylindrical front housing 202 with a circular face. In other embodiments, however, the front housing is configured with other shaped exteriors to present a front housing that is not cylindrical and a face that is not circular. For example, the front housing 202 disclosed herein can be configured, for example, with a square face that extends downward to blend with the cylindrical rear housing such that the housing is not perfectly cylindrical and the face is square. In still other embodiments, the housing and/or face is constructed with other shapes consistent with wearable electronic devices having different outer appearances.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically.

A device or structure that is “configured” in a certain way is configured in at least that way, but may also be configured in ways that are not listed. As used herein, the terms “configured to”, “configured with”, “arranged to”, “arranged with”, “capable of” and any like or similar terms mean that hardware elements of the device or structure are at least physically arranged, connected, and or coupled to enable the device or structure to function as intended.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An antenna system for a wearable electronic device, the antenna system comprising:
a first conductive surface constructed from a segment of outer housing of the wearable electronic device, wherein the first conductive surface spans a first axis through the wearable electronic device;
a second conductive surface that spans the first axis, wherein the second conductive surface is constructed from a set of contacting metal components that are internal to the wearable electronic device, wherein the first and second conductive surfaces are separated by a space;
a contact element having a feeding element that connects the first conductive surface to the second conductive surface along a plane that is normal to the first conductive surface.

2. The antenna system of claim 1, wherein the first conductive surface is constructed from a segment of outer housing of a wrist-worn electronic device.

3. The antenna system of claim 1, wherein the contact element further comprises a set of legs that includes a first leg that is located coincident with a first end of a slot antenna formed from the first and second conductive surfaces and a second leg that is located coincident with a second end of the slot antenna, wherein the feeding element is located between the first and second legs.

4. The antenna system of claim 3, wherein the first and second legs comprise first and second frequency setting elements the locations of which control a radiating frequency for the slot antenna.

5. The antenna system of claim 4, wherein the contact element further comprises at least one frequency suppression element configured to suppress one or more undesired radiating frequencies.

6. The antenna system of claim 5, wherein the first and second frequency setting elements and the at least one frequency suppression element are constructed into a single piece of metal.

7. The antenna system of claim 6, wherein the single piece of metal is curved.

8. The antenna system of claim 7, wherein the single piece of metal has a curvature that corresponds to a curvature of the outer housing of the wearable electronic device.

9. The antenna system of claim 1, wherein the outer housing has a cylindrical shape such that the segment of the outer housing from which the first conductive surface is constructed is curved.

10. The antenna system of claim 1, wherein the feeding element connects a segment of a printed circuit board, which is one of the contacting metal components, to the first conductive surface.

11. The antenna system of claim 1, wherein the first conductive surface is seamless.

12. The antenna system of claim 1, wherein at least one dimension of the space between the first and second conductive surfaces changes.

13. A wearable electronic device comprising:
a rear housing component;
a front housing component connected to the rear housing component at a first edge and the front housing component having an opening at a second opposing edge;
internal components at least partially enclosed by the front and rear housing components, wherein the internal components include a display having a surface that spans the opening of the front housing component;
an antenna system comprising:
a first conductive surface constructed from a segment of the front housing component, wherein the first conductive surface is disposed normal to the surface of the display;
a second conductive surface disposed normal to the surface of the display, wherein the second conductive surface is constructed from a set of contacting metal components of the internal components, wherein the first and second conductive surfaces are separated by a space;
a contact element having a feeding element that connects the first conductive surface to the second conductive surface along a direction that is normal to the first conductive surface.

14. The wearable electronic device of claim 13, wherein an edge of the surface of the display aligns with the second edge of the front housing component.

15. The wearable electronic device of claim 13 further comprising a metal component connected to an outside surface of the front housing component proximal to the first conductive surface.

16. The wearable electronic device of claim 13, wherein the set of contacting metal components of the internal components comprises a printed circuit board disposed adjacent to the rear housing component, wherein the printed circuit board includes a communication element configured to wirelessly communicate using the antenna system, wherein the set of contacting metal components further comprises a shield disposed adjacent to the printed circuit board and a display bezel disposed adjacent to the shield and the display, wherein the feeding element connects the communication element on the printed circuit board to the first conductive surface of the antenna system.

17. The wearable electronic device of claim 13, wherein the front housing component has a cylindrical shape, and the contact element has a semi-circular shape that conforms to the cylindrical shape of the front housing component and that sits within the rear housing component.

18. The wearable electronic device of claim 17, wherein the contact element further comprises at least first, second, and third extension members, wherein the first and second extension members are configured to set a desired radiating frequency for the antenna system, and the third extension member is configured to suppress an undesired radiating frequency.

19. A method for assembling a wearable electronic device having a slot antenna, the method comprising:
layering a contact element, a printed circuit board, and a display onto at least one of a rear housing component or a front housing component, wherein the layering is performed along a first axis;
connecting the front housing component to the rear housing component to assemble the wearable electronic device such that a lateral surface of the front housing component extends along the first axis, wherein the connecting creates a slot antenna comprising:
a first conductive surface constructed from a segment of the lateral surface of front housing component;
a second conductive surface disposed along the first axis, wherein the second conductive surface is constructed from a segment of the printed circuit board and a segment of at least one metal element disposed between the printed circuit board and the display, wherein the first and second conductive surfaces are separated by a space; and
the contact element, wherein a feeding element of the contact element connects the first conductive surface to the segment of the printed circuit board along a direction that is normal to the first conductive surface.

20. The method of claim 19, wherein layering the contact element comprises disposing adjacent to a cylindrical rear housing component a semi-circular metallic ring having formed therein the feeding element, and connecting the front housing component to the rear housing component comprises connecting a cylindrical front housing component to the cylindrical rear housing component to assemble a wrist-worn electronic device.
